(19) United States
(12) Patent Application Publication
(10) Pub. No.: US 2020/0156008 A1
(43) Pub. Date: May 21, 2020

(54) MONOLITHIC MEMBRANE FILTRATION STRUCTURE

(71) Applicant: SAINT-GOBAIN CENTRE DE RECHERCHES ET D'ETUDES EUROPEEN, COURBEVOIE (FR)

(72) Inventors: Paul LEPLAY, ROBION (FR); Adrien VINCENT, PLAN D'ORGON (FR)

(21) Appl. No.: 16/617,718

(22) PCT Filed: May 31, 2018
(86) PCT No.: PCT/FR2018/051257

§ 371 Date: Nov. 27, 2019

(30) Foreign Application Priority Data
May 31, 2017 (FR) 1754822

(51) Int. Cl. B01D 63/06; B01D 29/52

(52) U.S. Cl. CPC B01D 63/066; B01D 2325/02; B01D 2315/08; B01D 29/52

(57) ABSTRACT

A filtration structure with a membrane for filtering liquids, includes a monolith including a support formed from a porous inorganic material of permeability Kₛ, the support having a tubular general shape with a main axis, an upstream face, a downstream face, a peripheral surface and an internal part; a plurality of channels parallel to the main axis of the support, formed in the internal part of the support, the channels being separated from each other by inner walls formed from the porous inorganic material; the channels being blocked at one or other of their upstream or downstream ends in the direction of circulation of the liquid, to define, respectively, inlet channels and outlet channels for the liquid, so as to force the liquid to pass through the porous walls separating the inlet and outlet channels, and a membrane covering the inner surface of at least the inlet channels.

The invention relates to the field of filtering structures made of inorganic material intended for filtering liquids, in particular structures coated with a membrane so as to separate particles or molecules of a liquid, more particularly of water, especially of production water derived from oil extraction or from shale gases.

Filters using ceramic or nonceramic membranes for filtering various fluids, especially polluted waters, have been known for a long time. These filters may function on the principle of tangential filtration, which makes it possible to limit the accumulation of particles, by means of the longitudinal circulation of the fluid at the surface of the membrane. The particles remain in the circulation stream whereas the liquid can cross the membrane under the effect of a pressure difference. This technique affords stability of the performance qualities and of the level of filtration. It is more particularly recommended for filtration of fluids that are highly charged with particles and/or molecules.

Another “frontal filtration” technique is also known, involving the passage of the fluid to be treated through a filtering medium, perpendicular to its surface. Frontal filters typically include channels that are alternately blocked so as to control inlet channels and outlet channels separated by filtering walls through which must pass the liquid to be filtered, which, on passing, becomes freed of its molecules or of its particles, thus forming the retentate which then cumulates in the inlet channels whereas the purified liquid escapes via the outlet channels or even partly via the periphery of the filter if said periphery is free. This technique is limited by the accumulation of particles and the formation of a cake at the surface of the filtering medium, but has the advantage of avoiding the installation of the recirculation circuit required for the tangential filtration technique.

The filters under consideration according to the present invention are made from monolithic structures or tubular supports made of a porous inorganic material formed from walls delimiting longitudinal channels parallel to the axis of said supports. The inner surface of the channels is covered with a separating membrane. This membrane comprises, or is even formed essentially by, a porous inorganic medium, the nature and morphology of which are adapted to stop polluting molecules or particles, insofar as their size is close to or greater than the median diameter of the pores of said membrane.

The inlet channels are open on passage of the liquid to be filtered on the upstream face (or front face) of the filter, with reference to the direction of circulation of the liquid to be filtered. These inlet channels are blocked on the downstream face (or opposite face) of said filter in the direction of circulation of the liquid. The outlet channels or channels for evacuating the filtered liquid are, in contrast, blocked on the upstream face of the filter and open on the downstream face of the filter.

Various geometries were proposed in order to improve the working properties of such membrane filters. Thus, patents U.S. Pat. No. 4,060,488 or 4,069,157 disclose filters formed from a porous support including channels at the surface of which is provided a membrane separating layer. The channels of these filters are not blocked and they function by tangential filtration.

Patent application WO 2009/121366 describes a frontal filter for filtering water. The filter includes parallel channels and a membrane. The structure of the channels is symmetrical, i.e. the cross section of the channels in a plane perpendicular to the main axis of said filter is identical, with the exception of the peripheral channels which are necessarily cropped due to the circular form of the filter.

Patent U.S. Pat. No. 5,114,581 also discloses a frontal filter with a membrane whose channels can be alternately blocked in a nonuniform pattern, and this filter is intended for filtering gases or even also liquids. The presence of a microporous membrane allows regeneration of the filter countercurrentwise and especially by backwashing. However, no indication is given in said publication regarding particular geometries for optimizing the liquid filtration qualities.

Proposals have been made for gaining in filtration area. However, none of the structures described to date in the prior art ensures maximum filtration efficacy, as regards the filtration of polluted liquids.

There is thus at the present time a need for a membrane filter, i.e. a filter comprising a porous support on the walls of which is deposited a filtration membrane, especially a filter of the frontal type, which has maximum filtration efficacy, i.e. which has optimized and maximized flow of the filtrate, for an equal bulk and for the same essential characteristics of the wall of the support and of the membrane.

In particular, the Applicant Company has discovered that such an optimization of the filtrate flow was based on a combined adaptation of the various constituent elements of the filtering structure. In other words, it has been discovered that the physical characteristics of the support, the physical characteristics of the membrane and the respective arrangement of the channels for the entry and exit of the fluids needed to be adjusted jointly to obtain maximum filtration efficacy.

In contrast with the preceding solutions which propose various configurations taking into account only the geometrical characteristics of the filters, the present invention is thus based on the principle of establishing a correlation between said geometrical characteristics and certain essential characteristics of the filtering membrane. Such a correlation had never been described hitherto.

More precisely, the present invention relates to a filtration structure with a membrane for filtering liquids, more particularly of the frontal filtration type, comprising at least one monolithic comprising:
a support formed from a porous inorganic material of permeability Kₛ, said support having a tubular general shape with a main axis, an upstream face (or base), a downstream face (or base) (according to the direction of circulation of the liquid), a peripheral surface and an inner part;
a plurality of channels parallel to the main axis of the support, formed in the internal part of the support, said channels being separated from each other by inner walls formed from the porous inorganic material;
said channels being blocked at one or other of their upstream or downstream end in the direction of circulation of said liquid, to define, respectively, inlet channels and outlet channels for said liquid, so as to force said liquid to pass through the porous walls separating the inlet and outlet channels;
a membrane of permeability Km and of mean thickness tm covering the inner surface of at least the inlet channels;
in which the mean path distance D of the liquid satisfies the relationship (1):

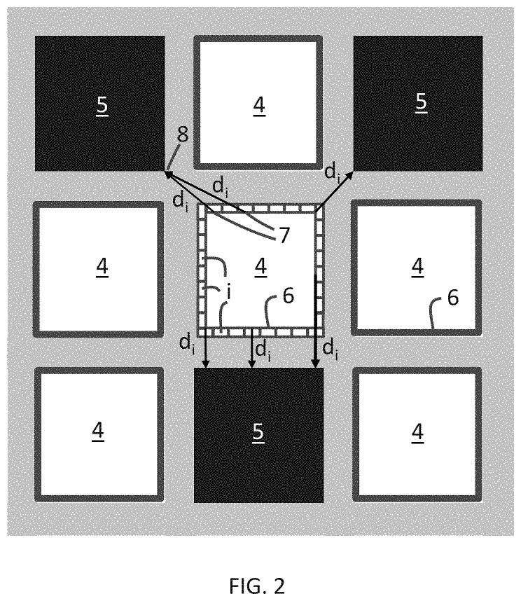

D=α×(A×log(Kₛ×tₘ/Kₘ)+B) (1)
in which:
α is a coefficient within a range between 0.0008 to 0.0013, preferably within a range between 0.0008 to 0.0012, more preferably within a range of between 0.0009 to 0.0011;
A=272×Ø_{c}272×pᵢ +0.02; and
B=601×Ø_{c}+1757×pᵢ+0.28;
Ø_{c} being the mean hydraulic diameter of all of the channels and
pᵢ being the mean thickness of the inner walls,
D, tₘ, Ø_{c}, pᵢ being expressed in m, and Kₛ and Kₘ being expressed in m²;
D is defined, on a plane of cross section perpendicular to the main axis of said structure, by the arithmetic mean of the distances di between i portions of the membrane covering each inlet channel and the closest outlet channel of each portion i of membrane, a portion i being defined as a division of said membrane into at least i parts of equal length, i being greater than 10, or even greater than 20, each di being measured from the central point of the inner surface of the membrane portion to the contact of the inner volume of said inlet channel up to the point of the inner wall of an outlet channel that is closest to said membrane portion. For further details, reference may be made, for example, to the attached FIG. 2.

According to preferred embodiments of the present invention, which may be combined together, where appropriate:
the ratio Ks×tm/Km is between 0.0005 and 5, preferably between 0.001 and 1;
the hydraulic diameter of the support is between 50 and 300 mm, preferably between 80 and 230 mm;
the mean hydraulic diameter of the channels Ø_{c} is between 0.5 and 8 mm, preferably between 0.5 and 7 mm, more preferably between 0.5 and 5 mm, preferably between 0.5 and 4 mm, and more preferably between 0.5 and 3 mm;
the mean thickness of the inner walls pi of the support is between 0.3 mm and 2 mm, preferably between 0.4 mm and 1.4 mm;
said structure is a frontal filtration filter;
the support has a square, hexagonal or circular base;
the filter has a length of between 200 and 1500 mm;
all the channels have an identical hydraulic diameter;
the mean thickness of the inner walls pᵢ is between 0.3 and 2 mm;
the support has an open porosity of between 20% and 70%;
the support has a median pore diameter of between 10 nm and 50 μm, preferably between 100 nm and 40 μm, more preferentially between 5 and 30 μm;
the mean thickness of the membrane tₘ is within a range from 0.1 to 300 μm, preferably ranging from 10 to 70 μm;
the membrane has an open porosity of between 10% and 70%;
the membrane has a median pore diameter of between 10 nm and 5 μm, preferably between 30 nm to 5 μm, more preferentially between 50 nm and 2000 nm and very preferably between 100 nm and 1000 nm;
the median pore diameter of the membrane is less than the median pore diameter of the support by a factor of at least 10 (i.e. their ratio is less than 10), or even less than at least a factor of 50 or even less than at least a factor of 100;
the channels have a circular or polygonal cross section, in particular a square or hexagonal cross section or an octagonal and square cross section;
preferably, the outer peripheral wall of the support is not filtering;
alternatively, the outer peripheral wall of the support may be filtering.

The invention also relates to the use of a filter as defined previously for purifying and/or separating liquids in the field of chemistry, pharmaceuticals, food, agrofood, bioreactors, or oil or shale gas extraction.

In the relationship (1), the magnitudes are expressed conventionally in the units of the international system, i.e. in meters (m) for the magnitudes D, tₘ, Ø_{c}, pᵢ and Ø_{f}, and in square meters (m²) for the magnitudes Kₛ and Kₘ.

The permeability of the support Kₛ and of the membrane Kₘ are defined on the basis of the Kozeny-Carman relationship by the following formula: K=(PO³×D₅₀²)/[180×(1−PO)²] in which PO is the open porosity between 0 and 1 (for example a porosity of 50% corresponds to a PO of 0.5) and D₅₀ is the median pore diameter in meters.

The open porosity and the median pore diameter of the support according to the present invention are determined in a known manner by mercury porosimetry. The porosity, corresponding to the pore volume, is measured by mercury intrusion at 2000 bar using a mercury porosimeter such as the Autopore IV series 9500 porosimeter from Micromeritics, on a 1 cm³ sample taken from a support block, the sampling region excluding the skin typically extending down to 500 microns from the surface of the block. The applicable standard is standard ISO 15901-1.2005 part 1. The pressure increase up to high pressure leads to the mercury being “pushed” into pores of increasingly smaller size. Mercury intrusion conventionally takes place in two steps. In a first step, mercury intrusion is performed at low pressure down to 44 psia (about 3 bar), using an air pressure to introduce the mercury into the largest pores (>4 μm). In a second stage, intrusion at high pressure is performed with oil up to a maximum pressure of 30 000 psia (about 2000 bar). By applying the Washburn law mentioned in standard ISO 15901-1.2005 part 1, a mercury porosimeter thus makes it possible to establish a volume-based pore size distribution. The median pore diameter of the support corresponds to the threshold of 50% by volume of the population.

The porosity of the membrane, corresponding to the total volume of pores in the membrane, and the median pore diameter of the membrane are advantageously determined according to the invention using a scanning electron microscope. In the context of the present invention, it is considered that the porosity obtained for the membrane via this method may be likened to the open porosity. Typically, sections of a wall of the support are taken in cross section, so as to visualize the entire thickness of the coating over a cumulative length of at least 1.5 cm. Image acquisition is performed on a sample of at least 50 grains, preferably of at least 100 grains. The area and the equivalent diameter of each of the pores are obtained from the images via standard image analysis techniques, optionally after binarization of the image directed toward increasing the contrast thereof. An equivalent diameter distribution is thus deduced, from which the median pore diameter is extracted. The porosity of the membrane is obtained by integration of the equivalent pore diameter distribution curve. Similarly, a median size of the particles constituting the membrane layer may be determined via this method. One example of determining the median pore diameter or the median size of the particles constituting the membrane layer, by way of illustration, comprises the following succession of steps, which is conventional in the field:

a series of SEM images is taken of the support with its membrane layer observed in a cross section (i.e. throughout the thickness of a wall). For greater sharpness, the images are taken on a polished section of the material. The image acquisition is performed over a cumulative length of the membrane layer at least equal to 1.5 cm, so as to obtain representative values of the sample as a whole. The images are preferably subjected to binarization techniques, which are well known in the art of image processing, to increase the contrast of the contour of the particles or of the pores.

For each particle or each pore constituting the membrane layer, measurement of its area is performed. An equivalent pore or grain diameter is determined, corresponding to the diameter of a perfect disk of the same area as that measured for said particle or for said pore (this operation possibly being performed using dedicated software, especially Visilog® sold by Noesis). A particle or grain size distribution or pore diameter is thus obtained on a conventional distribution curve and a median size of the particles and/or a median diameter of the pores constituting the membrane layer are thus determined, this median size or this median diameter corresponding, respectively, to the equivalent diameter dividing said distribution into a first population including only particles or pores with an equivalent diameter greater than or equal to this median size and a second population including only particles with an equivalent diameter less than this median size or this median diameter.

In the present patent application, the hydraulic diameter of the filter or of a channel is conventionally defined by the formula 4×S/P, S being the overall area of the section of the filter perpendicular to the main axis, or the area of the section of the channel perpendicular to the main axis, and P being the perimeter of this section.

The shape of the support defines the general shape of the filter. It has a tubular shape elongated along a main axis and comprises an upstream base, a downstream base, a peripheral surface and an internal portion. The upstream and downstream bases, which are of identical shapes and sizes, may be of varied shape, for example square, hexagonal or circular. They are preferably circular. The downstream face (or base) is intended to be positioned on the side of the entering liquid stream (liquid to be filtered) and the upstream face (or base) opposite the entering liquid stream. The support typically has a hydraulic diameter Ø_{f} of from 50 to 300 mm, preferably 80 to 230 mm. The length of the support may be between 200 and 1500 mm.

A plurality of channels parallel to the main axis of the support is formed in the internal portion of the support. These channels, also known as filtering channels, are blocked at one or other of their ends to define inlet channels and outlet channels, in the direction of flow of the fluids. The inlet channels thus have an inlet face (upstream in the direction of circulation of the fluids) which is not blocked and a blocked outlet face. The outlet channels thus have a blocked upstream front face in the direction of circulation of the fluids and an unblocked face on the downstream front side of the filtration structure.

The shape of the channels is not limited and said channels may have a polygonal cross section, especially hexagonal or square or octagonal/square, or alternatively circular, but preferably have a circular or square cross section. The mean hydraulic diameter of the channels Ø_{c} is generally from 0.5 to 5 mm, preferably 0.5 to 4 mm, more preferably between 0.5 and 3 mm. The filter may comprise several categories of channels, besides the peripheral channels which may be truncated to adapt the dimensions of the filter. One category of channels is defined by a set of channels having the same shape and an identical hydraulic diameter to within ±5%. For example, the filter may comprise a first category of channels formed from channels located close to the peripheral surface of the filter and a second category formed from channels located at the center of the filter, the channels of the first category having a higher hydraulic diameter than those of the second category. In the case of a plurality of channels whose hydraulic diameter is different, the hydraulic diameter intrinsic to each of the channels is defined according to the invention, as calculated from the preceding formula (4×S/P). As is well known, the mean hydraulic diameter Ø_{c} of all of the channels is determined as being the arithmetic mean of the individual hydraulic diameters of all of the channels present in the filter. However, preferably, the filter comprises only one category of channels.

The channels are separated from each other by inner walls formed by the porous inorganic material of the support. The mean thickness of the inner walls pᵢ is typically from 0.3 to 2 mm, preferably from 0.4 to 1.4 mm.

The support is formed from a porous inorganic material, especially a non-oxide ceramic material, such as SiC, in particular recrystallized SiC, Si₃N₄, Si₂ON₂, SiAlON, BN or a combination thereof. Its porosity is typically from 20% to 70%, preferably from 40% to 50%, and the median pore diameter from 5 nm to 50 μm, preferably from 100 nm to 40 μm, more preferentially from 5 to 30 μm. The permeability of the support Kₛ is preferably between 1.0×10⁻¹⁵ and 1.0×10⁻¹², preferably between 6.9×10⁻¹⁵ and 3.4×10⁻¹¹ m².

The filter also comprises a membrane covering the inner surface of the channels. It is formed from a porous inorganic material, in particular a non-oxide ceramic material, such as SiC, in particular recrystallized SiC, Si₃N₄, Si₂ON₂, SiAlON, BN or a combination thereof. Its porosity is typically from 10% to 70% and the median pore diameter from 10 nm to 5 μm, preferably between 50 nm to 1 μm (1 micrometer). The membrane permeability Kₘ is preferably from 10⁻¹⁹ to 10⁻¹⁴ m². The membrane typically has a mean thickness tm of from 0.1 to 300 μm, preferably from 1 to 200 μm, more preferentially from 10 to 80 μm.

The filter according to the invention may be obtained via any technique that is well known to those skilled in the art. A conventional manufacturing process generally comprises the main steps for manufacturing the support and then depositing the membrane.

The support is preferably obtained by extrusion of a paste through a die followed by drying and baking so as to sinter the material of the support and to obtain the porosity and mechanical strength characteristics required for the application. For example, when it is a support made of recrystallized SiC, it may in particular be obtained according to the following manufacturing steps:
blending of a mixture including silicon carbide particles with a purity of greater than 98% and having a particle size such that 75% by mass of the particles have a diameter greater than 30 μm, the mass-based median diameter of this particle size fraction measured by laser particle size analysis being less than 300 μm. The mixture also includes an organic binder of the cellulose derivative type. Water is added and the mixture is blended until a homogeneous paste whose plasticity allows extrusion is obtained, the die being configured to obtain monoliths according to the invention,
drying of the crude monoliths by microwave for a time sufficient to bring the content of the water that is not chemically bound to less than 1% by mass,
blocking of the monoliths may be formed according to well-known techniques, for example those described in patent application WO 2004/065088,
baking up to a temperature of at least 1900° C. and less than 2400° C. typically maintained for at least 1 hour and preferably for at least 3 hours. The material obtained has an open porosity of from 20% to 70%, preferably from 40% to 50% by volume and a median pore diameter of about from 5 nm to 50 μm, preferably from 100 nm to 40 μm, more preferentially from 5 to 30 μm.

The filtering support is then coated with a membrane. The membrane may be deposited according to various techniques known to those skilled in the art: deposition from suspensions or slips, chemical vapor deposition (CVD) or deposition by thermal spraying, for example plasma spraying. Preferably, the membrane layer(s) are deposited by coating using slips or suspensions. The membrane may be obtained by deposition of several successive layers. The membrane lies on a first layer, known as the primer, deposited in direct contact with a substrate. The primer acts as attachment layer. The slip used for the deposition of the primer preferably comprises between 30% and 70% by mass of SiC grains with a median diameter of from 1 to 30 μm, the remainder being, for example, a powder of silicon metal, of silica and/or a carbon powder. A mass of deionized water corresponding to 80% to 120% of the total mass of powders is added to this powder mixture. The membrane is made from a separating layer deposited on the primer layer. It is in this separating layer that the porosity is controlled so as to give the filter its selectivity. The slip used for depositing the separating layer may comprise between 30% and 70% by mass of SiC grains with a median diameter of from 0.5 to 20 μm or between 30% and 70% by mass, in total, of a mixture of silicon metal, of silica and of carbon, the remainder being deionized water. Certain additives such as thickeners, binders and/or dispersants may be added to the slips so as to control their rheology in particular. The viscosity of the slips is typically from 0.01 to 0.8 Pa·s, preferably from 0.05 to 0.7 Pa·s, measured at 22° C. at a shear gradient of 1 s⁻ according to standard DIN 53019-1:2008. The slips may typically comprise from 0.1% to 1% by mass of water of thickeners preferably chosen form cellulose derivatives. They may typically comprise from 0.1% to 5% by mass of SiC powder of binders preferably chosen from poly(vinyl alcohol) (PVA) and/or acrylic derivatives. The slips may also comprise from 0.01% to 1% by mass of SiC powder of dispersants preferably chosen from polyammonium methacrylates. One or more layers of slip may be deposited so as to form the membrane. The deposition of a layer of slip typically makes it possible to obtain a membrane with a thickness of from 0.1 to 80 μm, but thicker membranes typically from 100 to 300 μm may be obtained by depositing several successive layers of slip.

The support thus coated is then dried at room temperature typically for at least 30 minutes and then at 60° C. for at least 24 hours. The supports thus dried are sintered at a baking temperature typically between 1000 and 2200° C. under a nonoxidative atmosphere, preferably under argon so as to obtain a membrane porosity measured by image analysis of from 10% to 70% by volume and a median equivalent pore diameter measured by image analysis of from 10 nm to 5 μm.

In the case of a use as immersed filter, the periphery of the support is preferably coated with a membrane, in addition to the inner surface of the inlet channels.

The filter according to the invention may be used for various applications in the purification of liquids and/or separation of particles or molecules from a liquid. The filter according to the invention makes it possible to maximize the filtrate stream independently of the viscosity of the liquid to be filtered. It may thus be used for filtering liquids having, for example, a dynamic viscosity of from 0.1 to 20 mPa·s, or even 50 mPa·s. The dynamic viscosity of the fluid to be filtered may be measured at 20° C., under a shear gradient of 1 s⁻ according to standard DIN 53019-1:2008. The present invention relates especially to the use of a filter as described above for the purification of production water derived from oil extraction or from shale gases. It also finds its application in various industrial processes for purifying and/or separating liquids in the field of chemistry, pharmaceuticals, food, agrofood or bioreactors, and also in swimming pool waters.

The figures attached hereto illustrate in greater detail certain aspects of the present invention. The information given herein below should not, however, be considered as restricting the scope of the invention, in any of the aspects of the invention described in the figures.

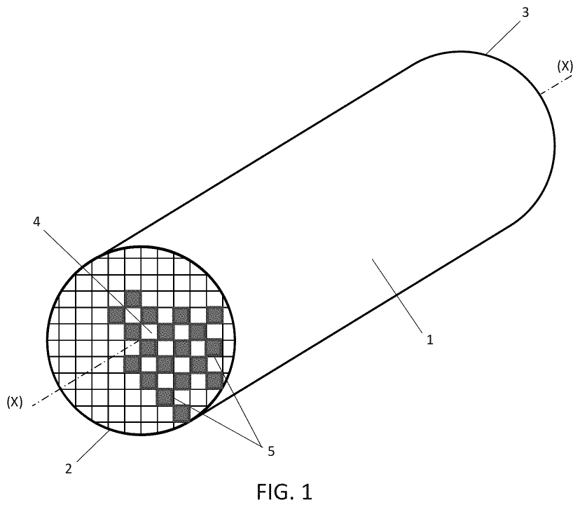

FIG. 1 illustrates an overall view of a common filtering structure (or filter).

FIG. 2 is a front view of a part of the upstream face of the filter which illustrates in greater detail the subject matter of the present invention.

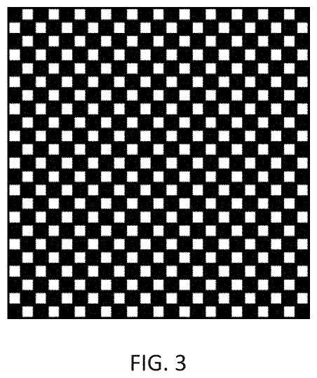

FIGS. 3 to 10 are also front views of a part of the upstream face of the filter in which the configuration of the channels is different.

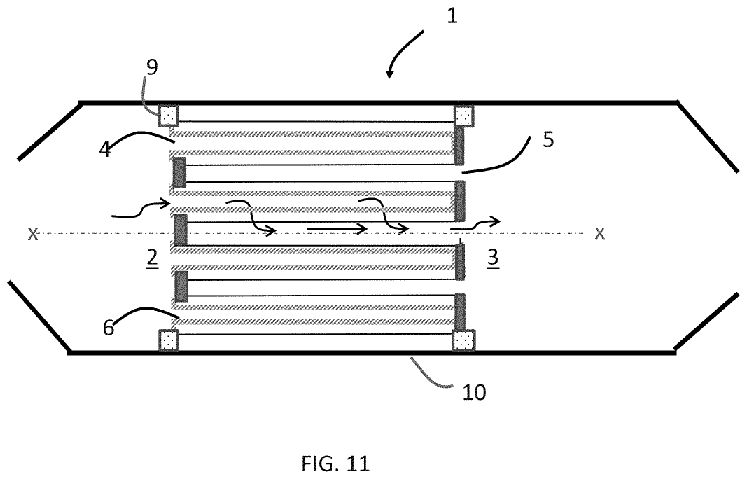

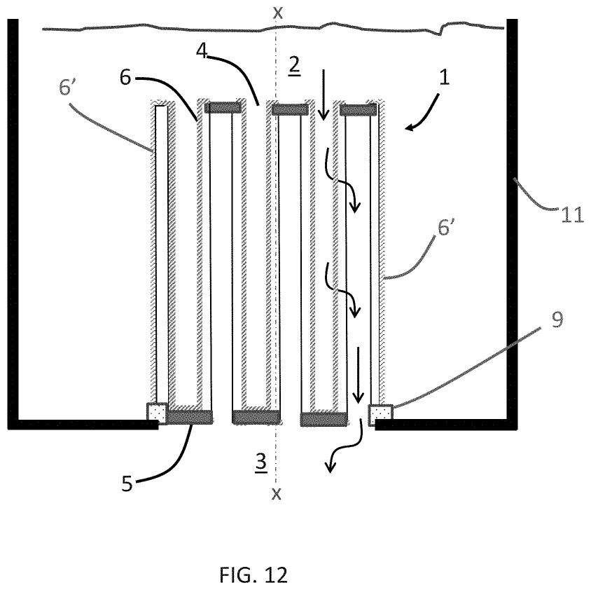

FIGS. 11 and 12 illustrate two embodiments of a filter according to the present invention.

FIG. 1 illustrates a frontal filtration filter comprising a cylindrical support 1 having a main axis (X), an upstream face 2 and a downstream face 3, in the direction of circulation of the liquid to be filtered. A plurality of channels parallel to the main axis (X) are formed in the internal part of the support and separated from each other by porous inner walls, comprising inlet channels 4 which are open on the upstream face and outlet channels 5 which are open on the downstream face, in the direction of circulation of the liquid. The inlet channels 4, emerging on each of the upstream bases 2 and downstream bases 3, are covered on their inner surface with a membrane (not shown in FIG. 1) and are blocked on their downstream face 3. The outlet channels 5 are blocked on their upstream face 2.

FIG. 2 is a view of the upstream face of a filter for illustrating the subject of the present invention in greater detail. A central inlet channel 4 and several outlet channels 5 of the filter, and also the filtering membrane 6 which lines the interior of each inlet channel, are shown in FIG. 2. This membrane is divided into i portions of equal length, as shown in FIG. 2. For each portion i, a distance di from the central point 7 of the inner surface of the membrane portion in contact with the inner volume of said inlet channel up to point 8 of the inner wall of an outlet channel that is closest to said membrane portion is determined. As may be seen in FIG. 2, various outlet channels 5 can and must be considered as a function of the position of the membrane portion i and of the blocking configuration and of the geometry of the channels.

The distance D that is relevant according to the present invention is the arithmetic mean of the di thus determined for all the portions i of all the inlet channels of each monolith.

The number of portions chosen in the section plane is advantageously chosen as a function of the configuration of the channels and of the number of outlet channels with regard to each inlet channel, but must be sufficient to be representative of the mean path of the liquid derived from an inlet channel to an outlet channel, across the porous wall of the support. Typically, the number of measurements of di per channel is greater than 10, or even greater than 20, preferably greater than 50, or even greater than 100. According to the invention, at least 20, preferably at least 50 or even 100 distances dᵢ are thus determined per inlet channel, for the calculation of D.

FIG. 3 is a front view of the upstream face of a filtration filter whose inlet and outlet channels are of square cross section, according to a first configuration of the blocking of the channels.

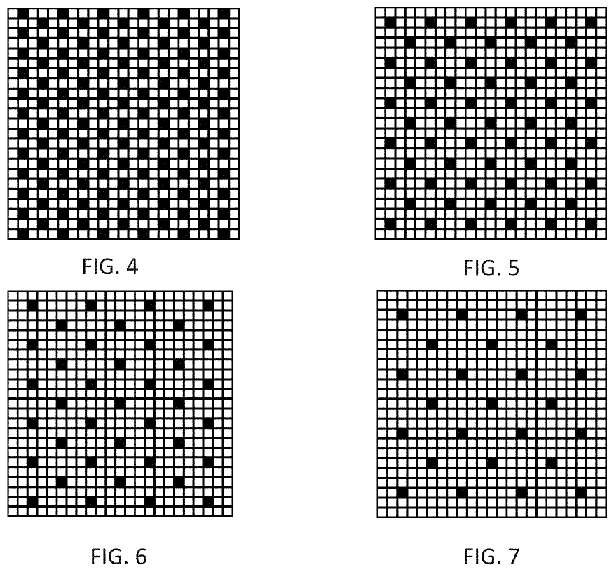

FIGS. 4 to 7 are front views of the upstream face of a filtration filter whose inlet and outlet channels are of square cross section, according to other configurations of the blocking of the channels.

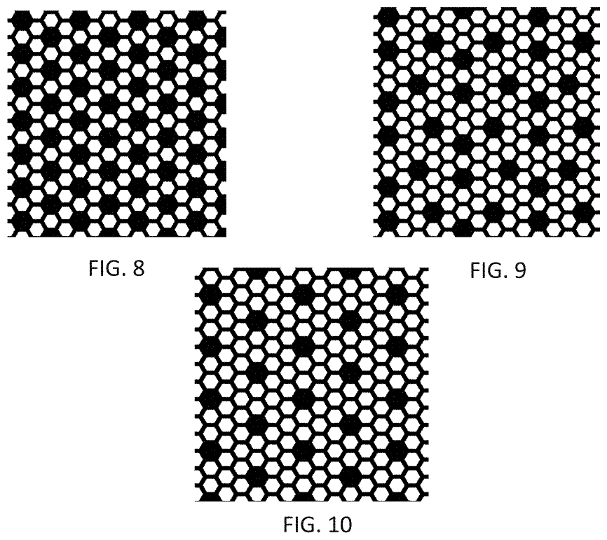

FIGS. 8 to 10 are front views of the upstream face of a filtration filter whose inlet and outlet channels are of hexagonal cross section, according to several configurations of the blocking of the channels.

FIGS. 11 and 12 illustrate two modes of functioning of such filters:

more particularly, FIG. 11 illustrates a longitudinal section (along a plane passing through the main axis) of a filtering structure (or filter) inserted in a compartment (housing).

FIG. 12 schematically represents a longitudinal section of a filter immersed in a reservoir of the liquid to be filtered.

FIG. 11 describes a frontal filtration filter inserted in a compartment 10 comprising a cylindrical support 1 having a main axis (X), an upstream face 2 and a downstream face 3. A plurality of channels parallel to the main axis (X) are formed in the inner part of the support and separated from each other by porous inner walls, comprising inlet channels 4 which are open on the upstream face and outlet channels 5 which are open on the downstream face, in the direction of circulation of the liquid. The inlet channels 4, emerging on each of the upstream bases 2 and downstream bases 3, are covered on their inner face with a membrane (6) and are blocked on their downstream face 3. The outlet channels 5 are blocked on their upstream face 2. The leaktightness of the system is ensured by a seal 9.

FIG. 12 schematically represents a frontal filtration filter immersed in a reservoir 11 comprising the liquid to be filtered. The components of the filter are similar to those of FIG. 11, except for the fact that the filter moreover comprises a coating 6′ on its outer periphery so that the liquid to be filtered does not circumvent the membrane by passing via the periphery directly into a peripheral outlet channel. This coating may be leaktight. If this coating is permeable, it comprises at least the membrane. The leaktightness on contact with the reservoir is ensured by a seal 9.

The present invention is illustrated with the aid of the nonlimiting examples that follow, in connection with the attached FIGS. 1 to 10.

### EXAMPLES

Examples of frontal filters according to the invention (examples 1-3, 2-1, 3-4, 3-5 and 4-2) and comparative examples (1-1; 1-2; 2-2; 2-3; 2-4; 3-1; 3-2; 3-3; 3-5; 4-1 and 4-3) were prepared according to the processes described below.

### Example 1-1 (Comparative)

A support was made according to the techniques well known to those skilled in the art by forming a silicon carbide honeycomb. To do this, the following are mixed in a blender:
3000 g of a mixture of the two powders of silicon carbide particles with a purity of greater than 98% comprising 70% by mass of a first powder of grains with a median diameter of about 11 μm and 30% by mass of a second powder of grains with a median diameter of about 0.9 μm; and
300 g of an organic binder of the cellulose derivative type.

About 25% by mass of water relative to the mass of SiC and of organic binder are added and blending is performed until a homogeneous paste is obtained, the plasticity of which allows extrusion to obtain a support with a porosity of 35%.

The support is extruded using this paste by means of a die to obtain a crude cylindrical monolithic block with a diameter of 150 mm and a length of 300 mm, the inner part of which has a plurality of channels of square cross section. The shape of the die is adapted to obtain channels of square cross section with a hydraulic diameter of 1.8 mm and inner walls with a mean thickness of 400 micrometers.

The crude monolith obtained is then dried to bring the content of water not chemically bound to less than 1% by mass, and then baked under argon up to a temperature of 2100° C. which is maintained for 5 hours. The support obtained has an open porosity of 35% and a median pore diameter of about 10 μm, as measured by mercury porosimetry.

The channels of the monolith are alternately blocked according to well-known techniques, for example described in patent application WO 2004/065088. So as to obtain a blocking geometry as shown in FIG. 3. The outer peripheral wall of the support is rendered nonfiltering.

A filtration membrane is then deposited on the inner surface of the channels. The deposition of the membrane is performed by coating with slips. To do this, a membrane attachment primer is made in a first stage, using a slip whose mineral formulation includes 48% by mass of a powder of black SiC grains (SIKA DPF-C), the median diameter D₅₀ of which is about 10 micrometers, 32% by mass of a powder of black SiC grains (SIKA FCP-07), the median diameter D₅₀ of which is about 2 micrometers, 13% by mass of a powder of silicon metal grains, the median diameter D₅₀ of which is about 4 micrometers, 7% of an amorphous carbon powder, the median diameter D₅₀ of which is about 1 micrometer. The whole is mixed in a solution of deionized water, the amount of water representing about 50% of the total mass of the mixture.

The membrane separating layer (the membrane) is obtained using a slip whose mineral composition is as follows: 67% by mass of powder of silicon metal grains, the median diameter D₅₀ of which is about 4 micrometers, 33% of amorphous carbon powder, the median diameter D₅₀ which is about 1 micrometer. The whole is mixed in a solution of deionized water, the amount of water representing about 50% of the total mass of the mixture.

The supports are then dried at room temperature for 10 minutes and then at 60° C. for 12 hours. The supports thus dried are then baked under argon at a temperature of 1470° C. for 4 hours at ambient pressure under argon.

The primer and the membrane are deposited according to the same process. The slip is introduced into a reservoir with stirring at 20 rpm. After a phase of de-aeration under a mild vacuum, typically 25 mbar, with continued stirring, the reservoir is placed under a mild excess pressure of about 0.8 bar so as to be able to coat the interior of the support from the bottom to the top. This operation only takes a few seconds for a support 300 mm long. The slip coats the inner wall of the channels of the support and the excess is then evacuated by gravity immediately after deposition. In practice, irrespective of its thickness, this layer of primer has no influence on the filtration performance qualities of the filter, given its porosity characteristics (median pore diameter and overall porosity) which are greater than that of the membrane itself, which thus acts alone as the separating layer.

The coated support is then dried at room temperature for 30 minutes and then at 60° C. for 30 hours.

The coated support thus dried is then sintered at a temperature of 1300° C. under an argon atmosphere for 4 hours to obtain a membrane porosity of 40% with a median pore diameter of 100 nm.

### Example 1-2 (Comparative)

A filter was prepared in an identical manner to that of example 1-1, the only difference being that blocking is performed according to the configuration described in FIG. 4.

### Example 1-3 (According to the Invention)

A filter was prepared in an identical manner to that of example 1-1, except that the blocking is performed according to the configuration described in FIG. 5.

### Examples 2-1 (According to the Invention) and 2-2 to 2-4 (Comparative)

A filter was prepared in an identical manner to that of example 1-1, except that the die was modified so as to obtain channels with a hydraulic diameter of 2.6 mm and a mean inner wall thickness of 800 micrometers. The mixture intended for the extrusion of the support comprises 65% by mass of a first powder of silicon carbide particles with a median diameter of about 11 μm and 35% by mass of a second powder of silicon carbide particles with a median diameter of about 0.9 μm.

In this series of examples, a membrane separating layer made of silicon carbide is then deposited on the inner wall of the channels according to the process described below:

a primer for attaching the separating layer is formed, in a first stage, using a slip whose mineral formulation includes 30% by mass of a powder of black SiC grains (SIKA DPF-C), the median diameter D₅₀ of which is about 11 micrometers, 20% by mass of a powder of black SiC grains (SIKA FCP-07), the median diameter D₅₀ of which is about 2.5 micrometers, and 50% of deionized water. A slip of the material constituting the separating layer is also prepared, the formulation of which includes 40% by mass of SiC grains (d50 in the region of 0.6 micrometer) and 60% of demineralized water. The rheology of the slips was adjusted by adding organic additives at 0.7 Pa·s under a shear gradient of 1 s⁻¹, measured at 22° C. according to standard DIN C33-53019.

These two layers are successively deposited according to the same process described below: the slip is introduced into a reservoir with stirring (20 rpm). After a phase of de-aeration under a mild vacuum (typically 25 millibar), with continued stirring, the reservoir is placed under a positive pressure of about 0.7 bar in order to be able to coat the interior of the support from its bottom part to its top extremity. This operation only takes a few seconds for a support 30 cm long. Immediately after coating the slip on the inner wall of the channels of the support, the excess is evacuated by gravity.

The supports are then dried at room temperature for 10 minutes and then at 60° C. for 12 hours and the channels are blocked according to the same procedure as for the series of examples 1-1 to 1-3.

The supports thus dried are then baked under argon at a temperature of 1540° C. for 2 hours at ambient pressure.

### Examples 3-1 to 3-3 (Comparative Examples) 3-4 and 3-5 (According to the Invention)

A filter was prepared in an identical manner to that of example 2-1, except that the die was modified so as to obtain channels with a hydraulic diameter equal to 1.9 mm and a wall thickness of 635 micrometers. Furthermore, the crude monolith obtained is baked up to a temperature of 2200° C. The support obtained has an open porosity of 50% and a median pore diameter of about 35 μm.

Blocking of the structures according to examples 3-1 to 3-4 was performed, respectively, in the same manner as for examples 1-1 to 1-3, respectively, according to FIGS. 3 to 6. A design according to FIG. 7 was produced according to example 3-5.

In this series of examples, the step of deposition and of drying of the separating membrane is performed twice successively (once only) so as to obtain a layer with a mean thickness of 50 micrometers. Furthermore, the rheology of the slip was adjusted by adding organic additives at 0.5 Pa·s under a shear gradient of 1 s⁻¹, measured at 22° C. according to standard DIN C33-53019.

### Examples 4-1 and 4-3 (Comparative Examples) and 4-2 (According to the Invention)

A filter was prepared in an identical manner to that of example 2-1, except that the die was modified so as to obtain a hexagonal structure as shown in FIG. 8, the channels of which have a hydraulic diameter of 2.0 mm and a mean inner wall thickness of 600 micrometers. Furthermore, the crude monolith obtained is baked up to a temperature of 2130° C. The support obtained has an open porosity of 40% and a median pore diameter of about 9 μm.

In this series of examples, the preparation of the separating membrane is performed as for example 2-1, but the coated supports are then baked under argon at a temperature of 1480° C. instead of 1540° C.

Blocking of the structures according to examples 4-1 to 4-3 was performed in the same manner as previously so as to obtain a blocked structure, respectively, according to FIGS. 8 to 10.

Table of Results and Test:

For each of these filters, the ratio Φ/Φₘₐₓ is determined, in which Φ is the characteristic flow of the filter under consideration and Φₘₐₓ is the flow measured for the most efficient filter of the same series of examples, for which an efficacy of 100% is attributed. The characteristic flow of a filter was evaluated according to the following method: at a temperature of 25° C., a fluid formed from demineralized water feeds the filters to be evaluated at a transmembrane pressure of 0.5 bar and a circulation speed in the channels of 2 m/s. The permeate is recovered at the filter outlet. Measurement of the characteristic flow of the filter is expressed in L/h/m/bar after 20 hours of filtration. The results obtained and also all the pertinent size characteristics of the filters thus obtained are collated in table 1 below.

Examples 1-3, 2-1 and 3-4 according to the invention correspond to optimum structures whose configuration moreover depends on the physical characteristics of the membrane and of the support. These examples demonstrate the importance of adapting the pattern and the number of inlet and outlet channels of the filter as a function of the physical parameters of the filter, such as the shape of the channels, the mean thickness of the inner walls, the mean thickness of the membrane, the median pore diameter of the membrane and the porosity of the membrane or of the support, so as to obtain a distance D according to the invention to maximize the flow of filtrate. The filters according to the invention thus dimensioned are characterized by an optimized and maximal flow of filtrate, as may be observed in the results reported in table 1.

The advantages of the present invention are also demonstrated on other types of filters different from the preceding examples by the totally different configuration of the inlet and outlet channels, which in this case have a hexagonal cross section, as shown in the attached FIGS. 8 to 10. The configurations according to FIGS. 8 to 10 differ in their number of inlet and outlet channels. The results obtained are reported in table 2 below. As for the filters whose channels have a square cross section, it is observed that maximum filtration efficiency, in the sense described previously, is obtained for the filter according to example 4-3 in accordance with the present invention, but the channels of which are in this case of hexagonal cross section.

TABLE 1

| | ex 1-1 | ex 1-2 | ex 1-3 | ex 2-1 | ex 2-2 | ex 2-3 | ex 2-4 | ex 3-1 | ex 3-2 | ex 3-3 | ex 3-4 | ex 3-5 |
|---|---|---|---|---|---|---|---|---|---|---|---|---|
| Hydraulic diameter of the channels | 1.8 | | | 2.6 | | | | 1.9 | | | | |
| Øc (mm) | | | | | | | | | | | | |
| Thickness of the inner walls | 0.400 | | | 0.800 | | | | 0.635 | | | | |
| pi (mm) | | | | | | | | | | | | |
| Open porosity of the substrate (%) | 35 | | | 40 | | | | 50 | | | | |
| Median pore diameter of the | 10 | | | 5 | | | | 35 | | | | |
| substrate (μm) | | | | | | | | | | | | |
| Membrane porosity (%) | 40 | | | 50 | | | | 45 | | | | |
| Median pore diameter of the | 100 | | | 350 | | | | 350 | | | | |
| membrane (nm) | | | | | | | | | | | | |
| Mean thickness of the membrane | 30 | | | 30 | | | | 50 | | | | |
| (separating layer) (μm) | | | | | | | | | | | | |
| Ks.tm/Km (m) | 0.171 | | | 0.002 | | | | 0.830 | | | | |
| Theoretical distance D according to | 1.3 < D < 2.1 | | | 0.6 < D < 1.0 | | | | 2.0 < D < 3.2 | | | | |
| the invention for α = | | | | | | | | | | | | |
| 0.0008 and 0.0013 (μm) | | | | | | | | | | | | |
| Blocking pattern according to | FIG. 3 | FIG. 4 | FIG. 5 | FIG. 3 | FIG. 4 | FIG. 5 | FIG. 6 | FIG. 3 | FIG. 4 | FIG. 5 | FIG. 6 | FIG. 7 |
| D measured (mm) | 0.41 | 0.73 | 1.51 | 0.81 | 1.31 | 2.45 | 3.15 | 0.64 | 1.01 | 1.85 | 2.37 | 3.15 |
| Relative flow | 40% | 87% | 100% | 100% | 96% | 55% | 37% | 56% | 84% | 96% | 100% | 98% |

TABLE 2

| | ex 4-1 | ex 4-2 | ex 4-3 |
|---|---|---|---|
| Hydraulic diameter of the channels Øc (mm) | 2.0 | | |
| Thickness of the inner walls pi (mm) | 0.600 | | |
| Open porosity of the substrate (%) | 40 | | |
| Median pore diameter of the substrate (μm) | 9 | | |
| Membrane porosity (%) | 40 | | |
| Median pore diameter of the membrane (nm) | 250 | | |
| Mean thickness of the membrane | 50 | | |
| (separating layer) (μm) | | | |
| Ks · tm/Km (m) | 0.065 | | |
| Theoretical distance D according to the | 1.3 < D < 2.2 | | |
| invention for α = 0.0008 and 0.0013 (mm) | | | |
| Blocking pattern according to | FIG. 8 | FIG. 9 | FIG. 10 |
| D measured (mm) | 0.75 | 1.80 | 2.3 |
| Relative flow | 29% | 100% | 88% |

1. A filtration structure with a membrane for filtering liquids, comprising at least one monolithic comprising:
a support formed from a porous inorganic material of permeability Kₛ, said support having a tubular general shape with a main axis, an upstream face, a downstream face, a peripheral surface and an inner part;
a plurality of channels parallel to the main axis of the support, formed in the internal part of the support, said channels being separated from each other by inner walls formed from the porous inorganic material;
said channels being blocked at one or other of their upstream or downstream end in the direction of circulation of said liquid, to define, respectively, inlet channels (4) and outlet channels for said liquid, so as to force said liquid to pass through the porous walls separating the inlet and outlet channels;
a membrane of permeability Kₘ and of mean thickness tm covering the inner surface of at least the inlet channels;
wherein the mean path distance D of the liquid satisfies the relationship (1):
D=α×(A×log(Kₛ×tₘ)+B) (1)
in which:
α is a coefficient within a range between 0.0008 to 0.0013;
A=272×Ø_{c}+272×pᵢ+0.02; and
B=601×Ø_{c}+1757×pᵢ +0.28;
Ø_{c} being the mean hydraulic diameter of all of the channels and
pᵢ being the mean thickness of the inner walls,
D, tₘ, Ø_{c}, pᵢ being expressed in m, and Kₛ and Kₘ being expressed in m²;
D being defined, on a plane of cross section perpendicular to the main axis of said structure, by the arithmetic mean of the distances di between i portions of the membrane covering each inlet channel and the closest outlet channel of each portion i of membrane, a portion i being defined as a division of said membrane into at least i parts of equal length, i being greater than 10, each dᵢ being measured from a central point of the inner surface of the membrane portion to a contact of the inner volume of said inlet channel up to a point of the inner wall of an outlet channel that is closest to said membrane portion.

2. The filtration structure as claimed in claim 1, wherein the ratio Ks×tm/Km is between 0.0005 and 5.

3. The filtration structure as claimed claim 1, wherein the hydraulic diameter of the support is between 50 and 300 mm.

4. The filtration structure as claimed in claim 1, wherein the mean hydraulic diameter of the channels Ø_{c} is between 0.5 and 5 mm.

5. The filtration structure as claimed in claim 1, wherein the mean inner wall thickness pᵢ of the support is between 0.3 mm and 2 mm.

6. The filtration structure as claimed in claim 1, wherein the support has square, hexagonal or circular bases.

7. The filtration structure as claimed in claim 1, wherein the filter has a length of from 200 to 1500 mm.

8. The filtration structure as claimed in claim 1, wherein all the channels have an identical hydraulic diameter.

9. The filtration structure as claimed in claim 1, wherein the support has an open porosity of between 20% and 70%.

10. The filtration structure as claimed in claim 1, wherein the support has a median pore diameter of between 10 nm and 50 μm.

11. The filtration structure as claimed in claim 1, wherein the mean thickness of the membrane tₘ is within a range from 0.1 to 300 μm.

12. The filtration structure as claimed in claim 1, wherein the membrane has an open porosity of between 10% and 70%.

13. The filtration structure as claimed in claim 1, wherein the membrane has a median pore diameter of between 10 nm and 5 μm.

14. The filtration structure as claimed in claim 1, wherein the channels have a circular or polygonal cross section.

15. A method comprising utilizing a filter as claimed in claim 1 for the purification and/or separation of liquids in the field of chemistry, pharmaceuticals, food, agrofood, bioreactors, or the extraction of oil or of shale gases.

16. The filtration structure as claimed in claim 2, wherein the ratio Ks×tm/Km is between between 0.001 and 1.

17. The filtration structure as claimed claim 3, wherein the hydraulic diameter of the support is between 80 and 230 mm.

18. The filtration structure as claimed in claim 4, wherein the mean hydraulic diameter of the channels Øc is between 0.5 and 3 mm.

19. The filtration structure as claimed in claim 5, wherein the mean inner wall thickness pᵢ of the support is between 0.4 mm and 1.4 mm.

20. The filtration structure as claimed in claim 11, wherein the mean thickness of the membrane tₘ is within a range from 10 to 70 μm.

21. The filtration structure as claimed in claim 15, wherein the membrane has a median pore diameter of between 50 nm and 1000 nm.

22. The filtration structure as claimed in claim 14, wherein the channels have a square, hexagonal or octagonal and square cross section.
